(19) United States
(12) Patent Application Publication
(10) Pub. No.: US 2007/0114937 A1
(43) Pub. Date: May 24, 2007

(54) Plasma display panel

(75) Inventor: Sang-Hun Jang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/594,108

(22) Filed: Nov. 8, 2006

(30) Foreign Application Priority Data
Nov. 24, 2005 (KR) 2005-112938

(51) Int. Cl. H01J 17/02

(52) U.S. Cl. 313/610

(57) ABSTRACT

A plasma display panel that includes a first substrate; a second substrate facing the first substrate; barrier ribs disposed between the first substrate and the second substrate and partitioning discharge spaces; pairs of discharge electrodes disposed between the first substrate and the second substrate in perpendicular to a direction in which the first substrate and the second substrate are disposed; dielectric layers disposed between the pairs of discharge electrodes in discharge spaces; and phosphor layers coated in the discharge spaces. The pairs of discharge electrodes perform a surface discharge perpendicularly so that the discharge easily spreads to overall regions of respective discharge cells.

### CROSS-REFERENCE TO RELATED PATENT APPLICATIONS

This application claims the benefit of Korean Application No. 2005-112938, filed Nov. 24, 2005, in the Korean Intellectual Property Office, the disclosure of which is incorporated herein in its entirety by reference.

### BACKGROUND OF THE INVENTION

1. Field of the Invention

Aspects of the present invention relate to a plasma display panel, and more particularly, to a plasma display panel in which discharge electrodes are disposed so as to perform a surface discharge between a plurality of substrates in a perpendicular direction.

2. Description of the Related Art

Conventionally, plasma display panels are flat display devices that display desired numbers, letters, or graphics by sealing a discharge gas filled between two substrates on which a plurality of electrodes are formed, applying a predetermined discharge voltage, if gas in discharge cells emits light due to the discharge voltage, applying a proper pulse voltage, and addressing a point where two electrodes cross each other.

Conventional 3-electrode surface discharge type plasma display panels include a first substrate, a second substrate, X and Y electrodes which are a pair of sustain discharge electrodes formed on the first substrate, a first dielectric layer burying the pair of sustain discharge electrodes, a protection layer formed on the first dielectric layer, address electrodes formed on the second substrate and disposed to cross the pair of sustain discharge electrodes, a second dielectric layer burying the address electrodes, barrier ribs disposed between the first substrate and the second substrate, and phosphor layers of red, green, and blue colors coating the surface of respective sidewalls of the barrier ribs and the second dielectric layer. A discharge gas is filled in a space between the first substrate and the second substrate to form a discharge region.

The operation of conventional plasma display panels will be briefly described.

An address voltage is applied between the Y electrodes and the address electrodes to select discharge cells for light-emission, a sustain discharge voltage is applied between the X electrodes and the Y electrodes to perform a surface discharge in the discharge regions of the first dielectric layer and the protection layer of the selected discharge cells, thereby generating ultraviolet rays, which excite a phosphor substance of the respective phosphor layers so that a still image or motion picture is displayed.

However, conventional plasma display panels have the following disadvantages.

First, the discharge starts in each selected discharge cell from a discharge gap between the X electrode and the Y electrode disposed on the inner surface of the first substrate so that the discharge diffuses outward from the X electrode and the Y electrode. That is, the discharge spreads in the plane of the first substrate. Therefore, an entire space of the discharge cell is not properly utilized.

Second, the address voltage is very high since the Y electrodes and the address electrodes are far away from each other.

Third, plasma etching occurs due to the discharge, which deteriorates lifetime of plasma display panels.

Fourth, the X electrodes, the Y electrodes, the first dielectric layer, and the protection layer are formed on the inner surface of the first substrate. Therefore, transmission of visible rays is less than 60%, which reduces brightness.

Fifth, when plasma display panels are driven for a long time, charge particles of a discharge gas produce ion sputtering on the phosphor layers due to an electric field, which causes afterimage.

### SUMMARY OF THE INVENTION

Aspects of the present invention provide a plasma display panel with an improved structure in which a surface discharge is performed from the center of discharge cells to a perpendicular direction in order to use an entire space of respective discharge cells.

Aspects of the present invention also provide a plasma display panel that can reduce an addressing voltage by reducing distances between electrodes that perform an addressing discharge.

According to an aspect of the present invention, there is provided a plasma display panel comprising: a first substrate; a second substrate facing the first substrate; barrier ribs disposed between the first substrate and the second substrate and partitioning discharge spaces; pairs of discharge electrodes disposed between the first substrate and the second substrate perpendicular to a direction in which the first substrate and the second substrate are disposed; dielectric layers disposed between the pairs of discharge electrodes in discharge spaces; and phosphor layers coated in the discharge spaces.

According to an aspect of the present invention, the pairs of discharge electrodes may include first discharge electrodes disposed on the bottom surface of the first substrate, and second discharge electrodes disposed on the upper surface of the second substrate.

According to an aspect of the present invention, the first discharge electrodes and the second discharge electrodes may include respectively first discharge electrode lines and second discharge electrode lines, and first and second discharge extension portions extending areas from the first discharge electrode lines and second discharge electrode lines in each discharge cell.

According to an aspect of the present invention, the dielectric walls may be disposed in the center of each discharge cell so that the pairs of discharge electrodes perform a surface discharge perpendicularly, and the pairs of discharge electrodes are disposed on the upper surface and the bottom surface of the dielectric walls.

According to an aspect of the present invention, the second discharge electrodes may be disposed between the second substrate and the barrier ribs.

According to an aspect of the present invention, the dielectric walls may be disposed between the first discharge extension portions and the second discharge extension portions.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partially cutaway exploded perspective view of a 3-electrode surface discharge type plasma display panel according to an embodiment of the present invention;

FIG. 2 is a cross-sectional view taken along the line I-I of the plasma display panel of FIG. 1, according to the shown embodiment of the present invention;

FIG. 3 is a plan view of a discharge electrode layout of the plasma display panel of FIG. 1, according to the shown embodiment of the present invention; and

FIG. 4 is a plan view of a discharge electrode layout according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

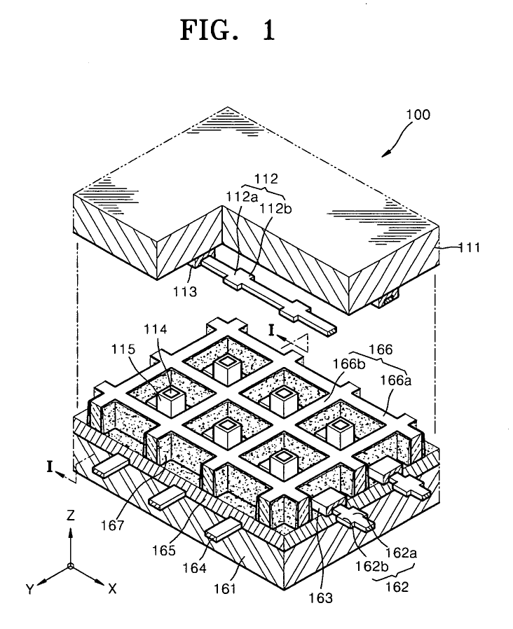

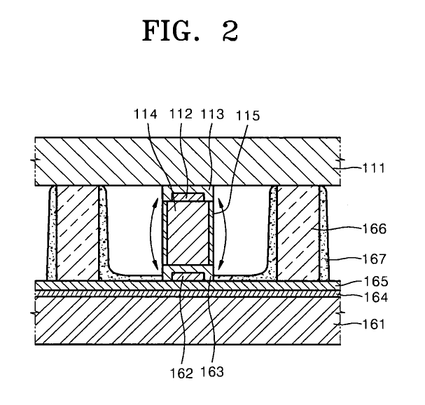

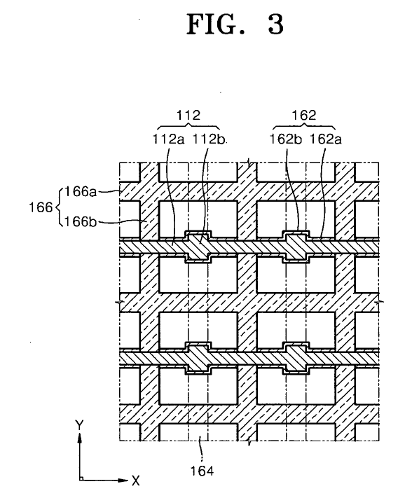

FIG. 1 is a partially cutaway exploded perspective view of a 3-electrode surface discharge type plasma display panel 100 according to an embodiment of the present invention. FIG. 2 is a cross-sectional view taken along the line I-I of the plasma display panel of FIG. 1. FIG. 3 is a plan view of a discharge electrode layout of the plasma display panel of FIG. 1.

Referring to FIGS. 1 through 3, the plasma display panel 100 includes a first substrate 111, and a second substrate 161 disposed parallel to the first substrate 111. The first substrate 111 and the second substrate 161 form a discharge space sealed by a frit glass (not shown) coated along opposing inside edges thereof.

The first substrate 111 is a transparent substrate such as soda lime glass, a semi-transparent substrate, a reflective substrate, or a colored substrate. X electrodes 112 are disposed inside the first substrate 111. The X electrodes 112 are disposed in each discharge cell in an X direction of the plasma display panel 100.

The second substrate 161 is substantially formed of the same material as the first substrate 111. Address electrodes 164 are disposed inside the second substrate 161. The address electrodes 164 are disposed to cross the X electrodes 112 disposed in a Y direction of the plasma display panel 100. The address electrodes 164 are buried by a third dielectric layer 165.

Y electrodes 162 are disposed on the third dielectric layer 165. The Y electrodes 162 are disposed in each discharge cell in an X direction of the plasma display panel 100. The Y electrodes 162 are buried by the third dielectric layer 165 but the present invention is not limited thereto.

The X electrodes 112 and the Y electrodes 162 are formed of a transparent conductive film, a silver paste having excellent conductivity to reduce line resistance of the X electrodes 112 and the Y electrodes 162, a metal material such as Cr—Cu—Cr, or a mixture thereof.

Barrier ribs 166 are disposed between the first substrate 111 and the second substrate 161. The barrier ribs 166 define discharge cells and prevent cross-talk between adjacent discharge cells.

Phosphor layers 167 of red, green, and blue colors are coated on the sidewalls of the barrier ribs 166 in respective discharge cells. The phosphor layer 167 of red color may be formed of (YGd)BO₃:Eu⁺³, the phosphor layer 167 of green color may be formed of Zn₂SiO₄:Mn²⁺, and the phosphor layer 167 of blue color may be formed of BaMgAl₁₀O₁₇:Eu²⁺.

Dielectric walls 114 are disposed between the X electrodes 112 and the Y electrodes 162 in each discharge cell. Protection layers 115 formed of magnesium oxide (MgO) can be formed on the surface of the dielectric walls 114 in order to increase an amount of secondary electron exhaust.

The X electrodes 112 and the Y electrodes 162 are correspondingly disposed. The dielectric walls 114 are formed between the X electrodes and the Y electrodes in each discharge cell.

In more detail, the X electrodes 112 are disposed on the inner surface of the first substrate 111. The X electrodes 112 extend across adjacent discharge cells in an X direction of the plasma display panel 100 and are spaced apart from each other by a predetermined gap in a Y direction of the plasma display panel 100.

The X electrodes 112 include first electrode lines 112a and first discharge extension portions 112b integrally formed with the first electrode lines 112a. The first electrode lines 112a are stripe type but the present invention is not limited thereto.

The first discharge extension portions 112b are protruded from both sidewalls of the first electrode lines 112a and form a rectangular shape with the first electrode lines 112a. The first discharge extension portions 112b can form polygon shapes other than the rectangular shape, such as a rhombus, pentagon, hexagon, etc., a circle shape, an oval shape, etc., with the first electrode lines 112a. The first discharge extension portions 112b are disposed in the center of respective discharge cells.

The X electrodes 112 can be buried by the first dielectric layer 113. The first dielectric layer 113 is selectively formed in regions where the X electrodes 112 are disposed or in entire regions on the inner surface of the first substrate 111.

The Y electrodes 162 are disposed parallel to the X electrodes 112. The Y electrodes 162 are disposed to correspond to the X electrodes 112 in a direction perpendicular to a direction in which the first substrate 111 and the second substrate 161 are disposed. Therefore, the Y electrodes 162 extend across adjacent discharge cells in an X direction of the plasma display panel 100, and the Y electrodes 162 are spaced apart from each other by a predetermined gap in a Y direction of the plasma display panel 100.

The Y electrodes 162 include second electrode lines 162a and second discharge extension portions 162b integrally formed with the second electrode lines 162a. The second electrode lines 162a form a stripe type pattern but the present invention is not limited thereto.

The second discharge extension portions 162b are protruded from both sidewalls of the second electrode lines 162a and form a rectangular shape with the second electrode lines 162a. The second discharge extension portions 162b are disposed in the center of respective discharge cells.

The Y electrodes 162 can be buried by the second dielectric layer 163. The second dielectric layer 163 can be selectively formed in regions where the Y electrodes 162 are disposed. Alternatively, the second dielectric layer 163 can be disposed in entire regions on the inside surface of the second substrate 161.

The dielectric walls 114 are formed between the X electrodes 112 and the Y electrodes 162. The dielectric walls 114 are disposed inside the discharge cells where the first discharge extension portions 112b and the second discharge extension portions 162b are formed. The upper surface of the dielectric walls 114 contacts the bottom surface of the first discharge extension portions 112b. The bottom surface of the dielectric walls 114 contacts the upper surface of the second discharge extension portions 162b.

The dielectric walls 114 are formed in a rectangular pillar shape in the center of each discharge cell. The protection layers 115 can be formed on the outer surface of the dielectric walls 114 in order to increase secondary electron emission. Alternatively, the dielectric walls 114 are not independently formed in each discharge cell but extend across adjacent discharge cells in an X direction of the plasma display panel 100 parallel to the X electrodes 112 and the Y electrodes 162.

The plasma display panel 100 includes the dielectric walls 114 between the X electrodes 112 and the Y electrodes 162 in the center of each discharge cells so that the X electrodes 112 and the Y electrodes 162 perform a surface discharge perpendicularly. In a 2-electrode plasma display panel, the X electrodes 112 and the Y electrodes 162 are disposed to cross each other so as to perform a sustain discharge and an addressing discharge.

The address electrodes 164 are formed on the second substrate 161 across the Y electrodes 162. The address electrodes 164 extend across adjacent discharge cells in a Y direction of the plasma display panel 100.

The address electrodes 164 are buried by the third dielectric layer 165. The third dielectric layer 165 is formed on entire regions of the second substrate 161 or can selectively bury a region where the address electrodes 164 are disposed but the present invention is not limited thereto.

The barrier ribs 166 defining discharge cells are disposed between the first substrate 111 and the second substrate 161. The barrier ribs 166 include first barrier ribs 166a disposed to cross the address electrodes 164 and second barrier ribs 166b disposed parallel to the address electrodes 164.

The barrier ribs 166 partition rectangular discharge spaces. Also, the discharge spaces defined by the barrier ribs 166 can have any shape other than the rectangular shape, such as a polygonal shape, a circle shape, or an oval shape, but the present invention is not limited thereto.

When the dielectric walls 114 are not formed in the rectangular pillar shape in the center of each discharge cell but in a stripe type pattern in an X direction of the plasma display panel 100, a predetermined portion of the second barrier ribs 166b can be removed to avoid interference with the dielectric walls 114.

The operation of the plasma display panel 100 having the above construction according to the current embodiment of the present invention will be described with reference to FIGS. 1 through 3.

When an address voltage is applied to the Y electrodes 162 and the address electrodes 164 from an external power source, a light-emitting discharge cell is selected. Wall charges are accumulated on the Y electrodes 162 of the selected discharge cells.

When a sustain discharge voltage is applied to the X electrodes 112 and the Y electrodes 162, the wall charges move due to a difference between the voltage applied between the X electrodes 112 and the Y electrodes 162.

In detail, the movement of the wall charges causes collisions of discharge gas atoms in the discharge spaces, which generate a discharge and plasma. The discharge starts by a discharge gap between respective X electrodes 112 and the Y electrodes 162 in which a relatively strong electric field is formed.

As time elapses, if a sufficient voltage difference between the respective X electrodes 112 and the Y electrodes 162 is sustained, an electric field formed between the respective X electrodes 112 and the Y electrodes 162 becomes more intensive so that the discharge spreads to the entire respective discharge spaces.

After the discharge is performed, when a voltage difference between the respective X electrodes 112 and the Y electrodes 162 is lower than a discharge voltage, no more discharge is performed and space charges and wall charges are formed in discharge spaces.

When the respective X electrodes 112 and the Y electrodes 162 exchange polarities, an initial discharge process repeats, thereby performing a stable discharge.

Ultraviolet rays generated by the discharge excite a phosphor substance of the phosphor layers 167 coated in each discharge space, which results in visible rays. The visible rays are emitted into respective discharge spaces to display an image.

The discharge starts by a discharge gap between the X electrodes 112 and the Y electrodes 162 which are perpendicularly disposed to a plane of the first and second substrates 111, 161 so that a plasma density is intensive around the discharge gap. The plasma spreads outward from respective X electrodes 112 and the Y electrodes 162 based on a high electron density and an ion density so that wall charges can be formed across the entire respective discharge regions.

During the sustain discharge, the first discharge extension portions 112b and the second discharge extension portions 162b are formed from both sidewalls of the first electrode lines 112a and both sidewalls of the second electrode lines 162a on the X electrodes 112 and the Y electrodes 162, respectively. Therefore, it is easy to utilize wall charges during a surface discharge in a perpendicular direction, so that the discharge can be stably performed and overall power consumption can be reduced.

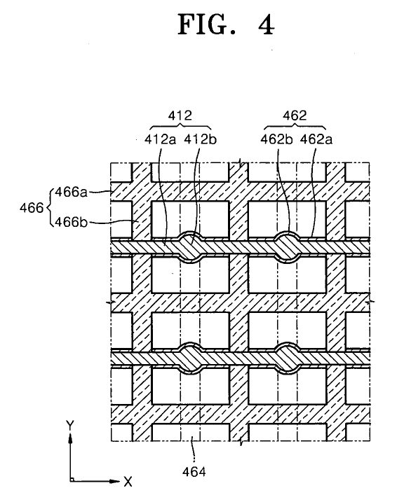

FIG. 4 is a plan view of a discharge electrode layout according to another embodiment of the present invention. The characterizing portion of the current embodiment of the present invention will be described except for the overlapping portions with the previous embodiment of the present invention.

Referring to FIG. 4, barrier ribs 466 include first barrier ribs 466a disposed in an X direction of a plasma display panel, and second barrier ribs 466b disposed in a Y direction of the plasma display panel across the first barrier ribs 466a. The second barrier ribs 466b extend to cross inside walls of the first barrier ribs 466a adjacent thereto, and partition rectangular shaped discharge cells.

X electrodes 412 are disposed parallel to the first barrier ribs 466a in each discharge cell. The X electrodes 412 include stripe shaped first electrode lines 412a and first discharge extension portions 412b integrally extending from the first electrode lines 412a to increase their area. The first discharge extension portions 412b are disposed in the center of respective discharge cells, and form a circle shape with the first electrode lines 412a.

Y electrodes 462 are disposed parallel to the X electrodes 412 in the discharge cells. The Y electrodes 462 include stripe shaped second electrode lines 462a and second discharge extension portions 462b integrally extending from the second electrode lines 462a to increase their area. The second discharge extension portions 462a are disposed to correspond to the first discharge extension portions 412a and form a circle shape with the second discharge electrode lines 462a.

The X electrodes 412 and the Y electrodes 462 perform a sustain discharge. Address electrodes 464 are disposed to cross the Y electrodes 462 and perform an addressing discharge.

Although not shown, the X electrodes 412 are disposed on an inside surface of a substrate, the Y electrodes 462 are disposed on an inside surface of another substrate, and dielectric walls in a cylinder shape are disposed between respective first discharge extension portions 412a and second discharge extension portions 462a in order to perform a surface discharge perpendicularly to the inside surfaces of the substrates.

The plasma display panel according to aspects of the present invention provide the following advantages.

First, a pair of sustain discharge electrodes can perform a surface discharge perpendicularly to the inside surfaces of the substrates in the center of each discharge cell, thereby easily diffusing a discharge to an entire region of the discharge cell.

Second, discharge extension portions are disposed in each discharge cell so that use of wall charges is increased. Therefore, a discharge is stably performed and overall power consumption is reduced.

Third, distances between respective Y electrodes and address electrodes are reduced so that an address voltage can be reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel comprising:
a first substrate;
a second substrate facing the first substrate;
barrier ribs disposed between the first substrate and the second substrate to partition discharge spaces;
pairs of discharge electrodes disposed between the first substrate and the second substrate, corresponding electrodes of each pair offset from each other perpendicular to a plane direction in which the first substrate and the second substrate are disposed;
dielectric layers disposed between the pairs of discharge electrodes in the discharge spaces; and
phosphor layers coated in the discharge spaces.

2. The plasma display panel of claim 1, wherein each pair of discharge electrodes includes a first discharge electrode disposed on a surface of the first substrate facing the second substrate, and a second discharge electrode disposed on a surface of the second substrate facing the first substrate.

3. The plasma display panel of claim 2, wherein the first discharge electrodes and the second discharge electrodes include respectively first discharge electrode lines and second discharge electrode lines, and first and second discharge extension portions extending areas from the first discharge electrode lines and second discharge electrode lines in each discharge space.

4. The plasma display panel of claim 3, wherein the first discharge electrode and second discharge electrode lines have a stripe shape.

5. The plasma display panel of claim 3, wherein the first discharge extension portions and the second discharge extension portions are integrally formed with the first discharge electrode lines and the second discharge electrode lines to have a polygonal shape, a circular shape, or a non-circular shape.

6. The plasma display panel of claim 3, wherein dielectric walls are disposed between the first discharge extension portions and the second discharge extension portions.

7. The plasma display panel of claim 3, wherein the first discharge electrodes and the second discharge electrodes are disposed parallel to each other on the first substrate and the second substrate respectively to perform the sustain discharge, and third electrodes are disposed to cross the second discharge electrodes on the first substrate or the second substrate to perform the addressing discharge with the second discharge electrodes.

8. The plasma display panel of claim 3, wherein dielectric walls are disposed in the center of each discharge space so that the pairs of discharge electrodes perform a surface discharge perpendicularly, and one of the discharge electrodes of the pairs of electrodes is disposed on a surface of each respective dielectric wall adjacent to the first substrate and the other of the discharge electrodes of the pairs of electrodes is disposed on an opposite surface of each respective dielectric wall adjacent to the second substrate.

9. The plasma display panel of claim 2, wherein the first discharge electrodes and the second discharge electrodes are disposed across the first substrate and the second substrate respectively to perform a sustain discharge and an addressing discharge.

10. The plasma display panel of claim 2, wherein the first discharge electrodes and the second discharge electrodes are disposed parallel to each other on the first substrate and the second substrate respectively to perform the sustain discharge, and third electrodes are disposed to cross the second discharge electrodes on the first substrate or the second substrate to perform the addressing discharge with the second discharge electrodes.

11. The plasma display panel of claim 2, wherein the first discharge electrodes are buried by a first dielectric layer, and the second discharge electrodes are buried by a second dielectric layer.

12. The plasma display panel of claim 11, wherein the first discharge electrodes and the second discharge electrodes extend across adjacent discharge spaces in a direction of the substrate, and the first dielectric layer and the second dielectric layer are selectively formed in regions where the first discharge electrodes and the second discharge electrodes are disposed.

13. The plasma display panel of claim 11, wherein the first discharge electrodes and the second discharge electrodes extend across adjacent discharge spaces in a direction of the substrate, and the first dielectric layer and the second dielectric layer are formed in entire regions of the first discharge electrodes and the second discharge electrodes.

14. The plasma display panel of claim 2, wherein the second discharge electrodes are disposed between the second substrate and the barrier ribs.

15. The plasma display panel of claim 1, wherein dielectric walls are disposed in the center of each discharge space so that the pairs of discharge electrodes perform a surface discharge perpendicularly, and one of the discharge electrodes of the pairs of electrodes is disposed on a surface of each respective dielectric wall adjacent to the first substrate and the other of the discharge electrodes of the pairs of electrodes is disposed on an opposite surface of each respective dielectric wall adjacent to the second substrate.

16. The plasma display panel of claim 15, wherein the dielectric walls have a pillar shape.

17. The plasma display panel of claim 1, wherein respective protection layers are formed on a surface of each dielectric wall that is not adjacent to the first and second substrates.

18. The plasma display panel of claim 1, wherein the barrier ribs comprise first barrier ribs disposed in an first planar direction of the plasma display panel, and second barrier ribs disposed in a second planar direction of the plasma display panel orthogonal to the first planar direction across the first barrier ribs, wherein the second barrier ribs extend to cross inside walls of the first barrier ribs adjacent thereto, and partition rectangular shaped discharge spaces.

19. A plasma display panel comprising:
a first substrate;
a second substrate facing the first substrate and spaced a predetermined distance from the first substrate;
barrier ribs disposed between the first substrate and the second substrate to partition discharge spaces;
first discharge electrodes disposed between the first substrate and the second substrate;
second discharge electrodes disposed between the first substrate and the second substrate corresponding to the first electrodes and spaced another predetermined distance from the first electrodes;
dielectric layers disposed between the first discharge electrodes and the second discharge electrodes in the discharge spaces; and
phosphor layers coated in the discharge spaces.

20. The plasma display panel of claim 19, wherein the first discharge electrodes are disposed on a surface of the first substrate facing the second substrate, and the second discharge electrodes are disposed on a surface of the second substrate facing the first substrate.
